(19) United States
(12) Patent Application Publication
(10) Pub. No.: US 2024/0120567 A1
(43) Pub. Date: Apr. 11, 2024

(54) ELECTROCHEMICAL PRODUCTION OF ALKALI METAL HYDROXIDES AND SULFURIC ACID FROM BATTERY MANUFACTURING AND RECYCLING OUTLET STREAMS

(71) Applicant: Redwood Materials, Inc., Carson City, NV (US)

(72) Inventors: Wesley Luc, Reno, NV (US); Henry von Schroeter, Reno, NV (US); Paul Voigt, Reno, NV (US)

(21) Appl. No.: 18/473,084

(22) Filed: Sep. 22, 2023

Related U.S. Application Data
(60) Provisional application No. 63/409,167, filed on Sep. 22, 2022.

(51) Int. Cl. H01M 10/54; C01D 5/02; C25B 1/34

(52) U.S. Cl. CPC H01M 10/54; C01D 5/02; C25B 1/34

(57) ABSTRACT

Methods of producing sodium hydroxide (NaOH) or lithium hydroxide (LiOH), and sulfuric acid (H₂SO₄), include generating sodium sulfate (Na₂SO₄) or lithium sulfate (Li₂SO₄) from battery manufacturing and recycling and converting the generated Na₂SO₄ or Li₂SO₄ to NaOH, LiOH, and H₂SO₄ via an electrochemical salt-splitting process. The processing steps can be carried out in a closed system such that the generated Na₂SO₄ or Li₂SO₄ can be used in the conversion process with optional purification steps. In particular, the LiOH, NaOH, and Na₂SO₄ are recycled into battery recycling or battery manufacturing processes.

### CROSS REFERENCE TO RELATED APPLICATIONS

This application claims the benefit of, and priority to, U.S. Provisional Application No. 63/409,167, filed Sep. 22, 2022. The aforementioned application is hereby incorporated by reference in its entirety.

### FIELD OF THE INVENTION

The present invention generally relates to chemical manufacturing and recycling, and in particular, to production of alkali metal hydroxides and sulfuric acid from battery manufacturing and recycling outlet streams.

### BACKGROUND

Sodium hydroxide (NaOH), lithium hydroxide (LiOH), and sulfuric acid (H₂SO₄) are important commodity chemicals that are heavily used across the chemical, pharmaceutical, energy, paper and pulp, and water industries, to name a few. For example, NaOH is widely used in the manufacturing of other chemicals owing to its basicity, LiOH is consumed in the production of cathode active materials for battery applications, and H₂SO₄ is heavily used to manufacture phosphate-based fertilizers.

Existing technologies for producing NaOH, LiOH, and H₂SO₄ are either process intensive or generate additional chemicals with hazardous concerns. For instance, high purity NaOH is mainly produced from brine using the chloralkali process that generates hazardous chlorine gas (Cl₂). In some instances, the production of LiOH can involve the extraction and purification of lithium carbonate (Li₂CO₃) from chloride-containing lithium minerals. For example, lithium chloride (LiCl) can be converted into Li₂CO₃ using sodium carbonate (Na₂CO₃) and then Li₂CO₃ further converted into LiOH using calcium hydroxide (Ca(OH)₂), all starting from salty brines. In other instances, the production of LiOH can occur by converting lithium sulfate (Li₂SO₄) generated from minerals into LiOH using NaOH. Finally, the production of H₂SO₄ can consist of multiple steps involving the extraction and conversion of sulfur (S) to sulfur dioxide (SO₂) through refining techniques, high temperature catalytic conversion of SO₂ to sulfur trioxide (SO₃), and subsequent conversion of SO₃ to H₂SO₄ with water.

### SUMMARY

One or more embodiments of the present disclosure includes systems and methods for generating one or more of NaOH, LiOH, or H₂SO₄ via electrochemical salt-splitting. For example, one or more implementations include utilizing outlet streams from lithium-ion battery manufacturing or recycling processes to generate sodium (Nat) or lithium (Lit) cations, and sulfate anions (SO₄²). Such implementations perform electrochemical salt-splitting to make one or more of NaOH, LiOH, or H₂SO₄, from the sodium (Na⁺) or lithium (Li⁺) cations, and the sulfate anions (SO₄²⁻).

For example, in one or more implementations, a method includes generating Na₂SO₄ from a battery manufacturing process. The method further involves converting the generated Na₂SO₄ to NaOH and H₂SO₄ via an electrochemical salt-splitting process. For example, the method involves electrochemically salt-splitting the Na₂SO₄ utilizing electrochemical cells comprising two or more compartments separated by one or more ion-exchange membranes. Furthermore, the method optionally includes converting the generated Na₂SO₄ to NaOH and H₂SO₄ without one or more purification techniques required by conventional industrial processes.

In another embodiment, a method includes generating Li₂SO₄ from a battery recycling process. The method further involves converting the generated Li₂SO₄ to LiOH and H₂SO₄ via an electrochemical salt-splitting process. For example, the method involves electrochemically salt-splitting the Li₂SO₄ utilizing electrochemical cells comprising two or more compartments separated by one or more ion-exchange membranes. Furthermore, the method optionally includes converting the generated Li₂SO₄ to LiOH and H₂SO₄ without one or more purification techniques required by conventional industrial processes.

Additional features and advantages of one or more embodiments of the present disclosure are outlined in the description which follows, and in part can be determined from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates a process diagram of generating sodium sulfate (Na₂SO₄) from a battery manufacturing process in accordance with one or more embodiments.

FIG. 2 illustrates a process diagram of converting Na₂SO₄ to sodium hydroxide (NaOH) and sulfuric acid (H₂SO₄) via an electrochemical salt-splitting process in accordance with one or more embodiments.

FIG. 3 illustrates a process diagram of generating lithium sulfate (Li₂SO₄) from a battery recycling process in accordance with one or more embodiments.

FIG. 4 illustrates a process diagram of converting Li₂SO₄ to lithium hydroxide (LiOH) and sulfuric acid (H₂SO₄) via an electrochemical salt-splitting process in accordance with one or more embodiments.

FIG. 5 illustrates conversion of Na₂SO₄ to NaOH and H₂SO₄ via a salt-splitting process using two- and three-compartment electrolysis cells in accordance with one or more embodiments.

FIG. 6 illustrates conversion of Li₂SO₄ to LiOH and H₂SO₄ via a salt-splitting process using two- and three-compartment electrolysis cells in accordance with one or more embodiments.

FIG. 7 illustrates conversion of Li₂SO₄ to LiOH and H₂SO₄ via a salt-splitting process using bi-polar membrane electrodialysis cells with three compartments in accordance with one or more embodiments.

FIG. 8 illustrates conversion of Na₂SO₄ to NaOH and H₂SO₄ via a salt-splitting process using bi-polar membrane electrodialysis cells with three compartments in accordance with one or more embodiments.

FIGS. 9 and 10 illustrate conversion of Li₂SO₄ to LiOH and H₂SO₄ via a salt-splitting process using bi-polar membrane electrodialysis cells with two compartments in accordance with one or more embodiments

FIG. 11 illustrates a flowchart of a series of acts for generating Na₂SO₄ from battery manufacturing and converting the same to NaOH and H₂SO₄ via an electrochemical salt-splitting process in accordance with one or more embodiments.

FIG. 12 illustrates a flowchart of a series of acts for generating Li₂SO₄ from battery recycling and converting the same to LiOH and H₂SO₄ via an electrochemical salt-splitting process in accordance with one or more embodiments.

### DETAILED DESCRIPTION OF THE INVENTION

This disclosure describes one or more embodiments of methods and systems of generating Na₂SO₄ and Li₂SO₄ from battery manufacturing processes and battery recycling processes, respectively, and converting the Na₂SO₄ and Li₂SO₄ to NaOH and LiOH, respectively, in combination with H₂SO₄. For example, in some embodiments, the disclosed systems and methods electrochemically split Na₂SO₄ or Li₂SO₄ outlet streams from battery manufacturing and recycling in aqueous solution to produce NaOH or LiOH, in combination with H₂SO₄, using electrochemical cells with two or more compartments separated by one or more ion-exchange membranes. The ion-exchange membrane can allow either alkali metal cations or SO₄²⁻ to transport to respective individual compartments. In one or more implementations, the electrochemical salt-splitting process includes electrolysis with an oxygen depolarized cathode, electrolysis with a hydrogen depolarized anode, electrolysis with a dimensionally stable anode, or bi-polar membrane electrodialysis.

In one or more implementations, the system utilizes electrolysis or bi-polar membrane electrodialysis for these salt-splitting processes. Further, in one or more implementations, the electrochemical salt-splitting process for converting the Na₂SO₄ or the Li₂SO₄ to NaOH or LiOH, respectively, in combination with H₂SO₄ can include bi-polar membrane electrodialysis. In electrolysis, the anode and cathode reactions can generate protons (H⁺) and hydroxides (OH⁻) and hence, H₂SO₄ and NaOH or H₂SO₄ and LiOH can be produced and accumulated in anolyte and catholyte, respectively. In bi-polar membrane electrodialysis, bi-polar ion-exchange membranes are the primary generators of H⁺ and OH⁻ rather than the anode and cathode reactions.

For example, in one or more implementations, a method includes generating Na₂SO₄ from a battery manufacturing process. The method further involves converting the generated Na₂SO₄ to NaOH and H₂SO₄ via an electrochemical salt-splitting process. For example, the method involves electrochemically salt-splitting the Na₂SO₄ utilizing electrochemical cells comprising two or more compartments separated by one or more ion-exchange membranes.

In one or more implementations, the methods involve generating Na₂SO₄ and converting the generated Na₂SO₄ to NaOH and H₂SO₄ in a closed system. In other words, once the Na₂SO₄ is generated from an outlet stream of battery manufacturing process, the methods involve introducing the outlet stream, in-situ (e.g., locally or on the premises), to the electrochemical cells for the salt-splitting process within a closed-loop system (e.g., integrated plant including battery materials manufacturing and recycling with electrolysis). Some embodiments involve reintroducing the resulting products, namely NaOH and H₂SO₄, from electrochemical salt-splitting processing back into battery manufacturing and recycling processes.

Furthermore, some embodiments involve managing concentration and purity upstream in the synthesis of precursor cathode active materials (pCAM) in connection with performing the conversion of Na₂SO₄ to NaOH and H₂SO₄. Additionally, or alternatively, the methods include utilizing high purity water to manage impurities. By managing inputs and impurities, the system can eliminate one or more purification steps required by most industrial electrochemical salt-splitting techniques, as discussed in further detail below.

In another embodiment, a method includes generating Li₂SO₄ from a battery recycling process. The method further involves converting the generated Li₂SO₄ to LiOH and H₂SO₄ via an electrochemical salt-splitting process. For example, the method involves electrochemically salt-splitting the Li₂SO₄ utilizing electrochemical cells comprising two or more compartments separated by one or more ion-exchange membranes.

Additionally, some embodiments involve generating Li₂SO₄ and converting the generated Li₂SO₄ to LiOH and H₂SO₄ in a closed or closed-loop system. In other words, once the Li₂SO₄ is generated from an outlet stream of the battery recycling process, the methods involve introducing the outlet stream, in-situ (e.g., locally or on the premises), within a closed or closed-loop system, to the electrochemical cells for the salt-splitting process. Similarly, some embodiments involve reintroducing the resulting products, namely LiOH and H₂SO₄, back into battery manufacturing and recycling processes. Additionally, one or more embodiments can include managing concentration and purity of inputs in the processing of recycling battery materials during the battery recycling process, which can result in elimination of, or streamlining of, downstream purification and processing steps when converting the Li₂SO₄ to LiOH and H₂SO₄.

Recently, electrochemical salt-splitting of alkali metal sulfates to produce their constituent hydroxides and acid has attracted interest as a modular platform to manufacture these chemicals. However, there are technical challenges associated with impurities that exist within battery manufacturing and recycling streams, which can poison the anode, cathode, and membranes leading to increased cell resistance, loss in current efficiency, and increased downtime to replace this components which leads to higher costs and lower productivity. Additionally, there are technical challenges producing contaminated acid streams, as contaminated acid is not a commercially fungible product.

Indeed, conventional industrial techniques often require multiple purification steps including: (1) starting with a solution of NaCl or salt water, (2) dissolving or preparing the solution into a concentrated brine, (3) cleaning the brine of any organics or solid particulates (e.g., microbes, algae, dust) via ultra filtration, (4) initial hardness removal via carbonation using CO₂ or soda ash, caustic soda (NaOH), CaCl₂, Ba(OH)₂, which removes Ca, Mg, and SO₄, (5) filtering out and removing solid precipitates, frequently via candle filter or other filter processes, (6) IX purification step to further remove Ca, Mg, (7) evaporation to concentrate the brine to near-saturation; and (8) pH adjustment to the target pH (pH=7).

Furthermore, the interest in sodium sulfate (Na₂SO₄) (as well as lithium sulfate (Li₂SO₄)) electrochemical salt-splitting stems from recent macro trends that have led to challenges in disposing or selling of Na₂SO₄ including by way of example, and not limitation, increased production of Na₂SO₄ owing to the battery industry's rapid growth thanks to electric vehicle (EV) adoption, global shift away from powder detergents, the largest end market for Na₂SO₄, and increased global scrutiny and environmental impacts/regulations limiting the dumping of Na₂SO₄ into rivers, lakes and oceans and limiting the sale of Na₂SO₄ across borders.

Advantages of the disclosed systems and methods include, by way of example, and not limitation, the elimination of one or more purification steps of the Na₂SO₄ or Li₂SO₄ outlet streams from battery manufacturing and recycling required by industrial electrochemical salt-splitting techniques to remove unwanted metal impurities as described in greater detail below. Further, the disclosed system provide improved production rates as these outlet streams are heavily concentrated with Na₂SO₄ and Li₂SO₄, and process intensification by electrochemically co-producing NaOH or LiOH with H₂SO₄.

More specifically, in some embodiments, the method of generating the Na₂SO₄ can include managing concentration and purity of inputs in the synthesis of precursor cathode active materials (pCAM), which can result in elimination of some purification steps when converting the Na₂SO₄ to NaOH and H₂SO₄. Likewise, one or more embodiments can include managing concentration and purity of inputs in the processing of recycling battery materials during the battery recycling process, which can result in elimination of, or streamlining of, downstream purification and processing steps when converting the Li₂SO₄ to LiOH and H₂SO₄.

Similarly, in some embodiments, the method of generating the Li₂SO₄ and converting the Li₂SO₄ to LiOH and H₂SO₄ can include managing concentration and purity of inputs in the processing of recycling battery materials during the battery recycling process, for example by managing the feedstock and reagents used. Furthermore, in some embodiments, this method can include managing impurities by utilizing high purity water. Indeed, by managing inputs and impurities, the system can eliminate some purification steps and streamline processes, such as crystallization techniques, to save capital and operating expenditures and simplify the process as described in greater detail below.

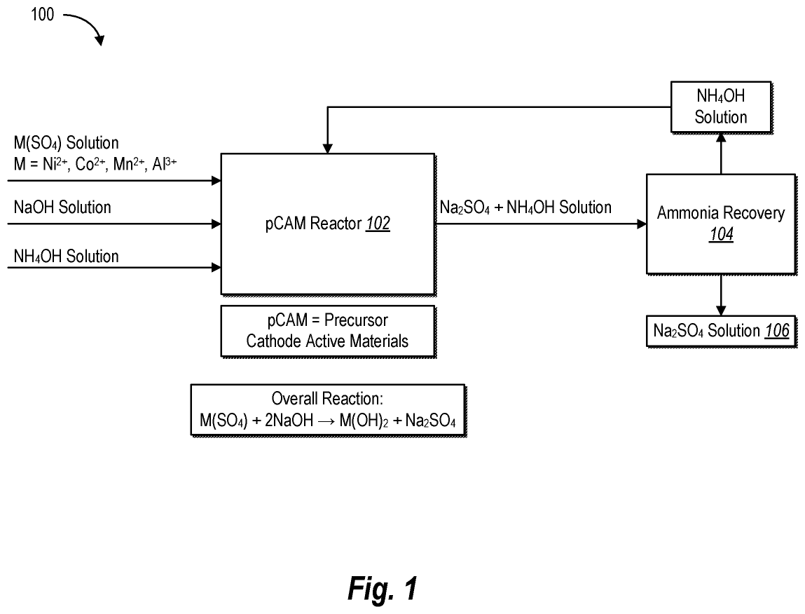

Reference is made to FIG. 1 which illustrates a process diagram for generating sodium sulfate (Na₂SO₄) from a battery manufacturing process 100 in accordance with one or more embodiments. In one or more embodiments, the battery manufacturing process 100 can generate Na₂SO₄ as a by-product from the synthesis of precursor cathode active materials (pCAM). For example, in one embodiment, the battery manufacturing process 100 includes synthesizing metal hydroxides (M(OH)₂), also known as pCAM, using a pCAM reactor 102. In some embodiments, the battery manufacturing process 100 can react metal sulfates (M(SO₄)), which can come as individual metal sulfates (e.g., NiSO₄, CoSO₄, MnSO₄), or mixtures of metal sulfates, with sodium hydroxide (NaOH) in the presence of ammonium hydroxide (NH₄OH). In these or other embodiments, the battery manufacturing process 100 can use NaOH as the precipitating agent while using NH₄OH as a chelating reagent to control the precipitation reaction. The overall precipitation reaction can be as described below in Equation (1).

M(SO₄)_{(aq)}+2NaOH_{(aq)}→M(OH)₂₍ₛ₎+Na₂SO_{4(aq)} (1)

In some implementations, as shown in Equation (1), the battery manufacturing process 100 can precipitate M(OH) 2 solids out while producing Na₂SO₄ as a by-product. In one or more embodiments, the battery manufacturing process 100 can pass this aqueous by-product stream containing Na₂SO₄ through a process for ammonia recovery 104 to remove valuable ammonia (NH 3) as NH₄OH solution that the battery manufacturing process 100 can subsequently recycle back to the plant for pCAM production. In some embodiments, the battery manufacturing process 100 can produce a Na₂SO₄ solution 106 after ammonia recovery 104 having the specifications as shown in Table 1.

TABLE 1
Sodium Sulfate Solution Composition.

```
Na₂SO₄, Solution Composition
  pH = 10-13
  Na2SO4 concentration = 88-150 gpl
  NaOH concentration = 0.0-0.5 gpl
  NH3 concentration = 0.0-0.2 gpl
  Trace quantities any element less than 20 ppm
    Ni, Co, Mn, Al, K, Ca, Mg, Cl, F
  In select instances, Ni content may be as high as 100 ppm
```

While the Na₂SO₄ solution 106 may have the composition as shown above, it will be appreciated by one skilled in the art that the Na₂SO₄ solution 106 can have other compositions or concentrations depending on the processing steps.

In some implementations, the battery manufacturing process 100 can produce a Na₂SO₄ solution 106 from the battery manufacturing process 100 having low contaminant concentrations. Indeed, the battery manufacturing process 100 can generate a Na₂SO₄ solution 106 in which a concentration of at least some of the contaminants in the solution is less than 20 parts per million (ppm). The generated Na₂SO₄ solution 106 can include various contaminants in aqueous ionic form such as nickel ions (Ni²⁺), cobalt ions (Co²⁺), manganese ions (Mn²⁺), aluminum ions (Al³⁺), potassium ions (K⁺), calcium ions (Ca²⁺), magnesium ions (Mg²⁺), chlorine ions (Cl⁻), or fluorine ions (F⁻). In some implementations, the system can include various methods to minimize the concentration of these contaminants in the Na₂SO₄ solution 106 generated from the battery manufacturing process.

For example, methods for minimizing the concentration of contaminants in the generated Na₂SO₄ solution 106 can include managing the inputs of the battery manufacturing process 100. For example, conventional battery manufacturing systems generally utilize water sourced from a municipality that is treated by reverse osmosis, which leaves quantities of the above-mentioned contaminants in the product streams such as the Na₂SO₄ solution 106. This level of purity is acceptable for conventional manufacturing systems but is typically not acceptable for electrochemical salt-splitting processes. In contrast, the one or more implementations can include utilizing deionized water in the battery manufacturing process 100 as a method for minimizing introduction of contaminants. Additionally, many of the reagents and feedstocks utilized in battery manufacturing can also introduce various contaminants. In contrast, one or more implementations further include utilizing reagents and feedstocks that do not have the contaminants or have only trace amounts of contaminants in the battery manufacturing process 100.

The methods described herein can further process the generated Na₂SO₄ solution 106 to generate NaOH and H₂SO₄. By minimizing the concentration in the Na₂SO₄ solution 106, the system can eliminate certain downstream techniques that would normally be required to generate the NaOH and the H₂SO₄ from the Na₂SO₄ solution 106.

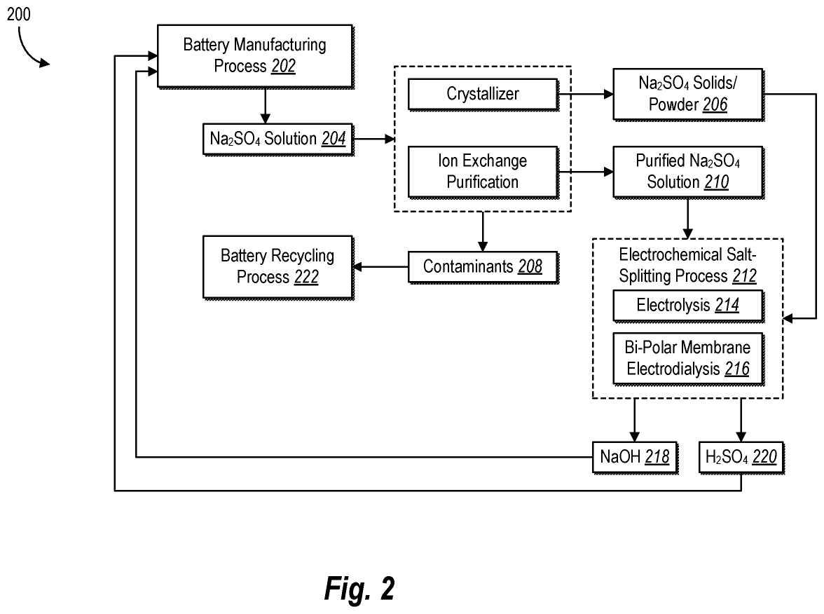

As mentioned above, in some embodiments, the system can further process Na₂SO₄ in its solution form (e.g., the Na₂SO₄ solution 106 or a Na₂SO₄ solution 204) generated from a battery manufacturing process 202. For instance, FIG. 2 illustrates a flowsheet of a method 200 for converting Na₂SO₄ to sodium hydroxide (NaOH) 218 and sulfuric acid (H₂SO₄) 220 via an electrochemical salt-splitting process 212. The method 200 can comprise various intermediate methods for processing the Na₂SO₄ solution 204 prior to subjecting the Na₂SO₄ solution 204 to an electrochemical salt-splitting process 212 as shown in FIG. 2. For example, in various embodiments, the method 200 can include intermediate processing steps, such as processing the Na₂SO₄ solution 204 through a crystallizer and/or purifying contaminants 208 from the Na₂SO₄ solution 204 by ion exchange purification.

For instance, in one embodiment, the method 200 can process the Na₂SO₄ solution 204 through a crystallizer to produce anhydrous Na₂SO₄ as crystalline solids or powder forms thereof. Moreover, in some embodiments, the Na₂SO₄ solution 204 may include contaminants 208 which the method 200 can further process through ion exchange methods as discussed in further detail below. Indeed, the Na₂SO₄ solution 204 can include trace quantities of various metals (e.g., nickel (Ni), cobalt (Co), manganese (Mn), aluminum (Al)) of considerable value. The method 200 can process these metals via, for example, crystallization or precipitation reactions, such that the method can isolate, recover, and/or recycle the trace quantities of these metals from the Na₂SO₄ solution 204 for input back into a battery recycling process 222. Indeed, by being located within a single combined plant, these processes can be directly interconnected to provide process intensification.

In one or more implementations, the by-product Na₂SO₄ solution 204 that the method 200 produces from ammonia recovery in the battery manufacturing process 202 may include the metal contaminants in aqueous ionic form, e.g., Ni²⁺, Co²⁺, Mn²⁺, Al³⁺. The contaminants 208 that the method 200 may produce can also include chlorine and fluorine ions similarly in aqueous ionic form (e.g., Cl⁻ and F⁻). In some embodiments, the method 200 can generate anhydrous Na₂SO₄ solids 206 by subjecting the Na₂SO₄ stream for processing through the crystallizer after ammonia recovery. In general, a crystallization step acts as a purification step for reducing impurities. In one or more implementations, a liquid purge stream with Na₂SO₄ and contaminants is separated, while a primary stream of Na₂SO₄ solids proceed to salt-splitting or are sent for sale.

As mentioned above, in some embodiments, prior to subjecting the Na₂SO₄ solution 204 to an electrochemical salt-splitting process 212 to generate NaOH 218 and H₂SO₄ 220, the method 200 can further purify the contaminants 208 from the Na₂SO₄ solution 204. As electrochemical devices are sensitive to metal impurities, residual metals in solution streams can poison membranes and electrodes, which can increase cell resistance and decrease performance. Because of this, many salt-splitting systems need feedstock to be pure which requires extra purification steps to remove residual metals, such as those described above. In some embodiments, the method 200 can ensure that the Na₂SO₄ solution 204 is sufficiently pure to use in the electrochemical salt-splitting process 212 without one or more of the conventionally required purification steps. For example, in one or more implementations, the pCAM process acts as a Ca, Mg removal process. In such implementations the methods include IX purification step and eliminates precipitative steps.

For example, in one or more implementations, the method 200 can utilize a single purification step, for instance, ion exchange purification to remove the contaminants 208 from the Na₂SO₄ solution 204. In many conventional systems, multiple methods are required to remove various contaminants 208 (e.g., Ca′ and Mg′) from any streams subjected to electrochemical salt-splitting. For example, conventional systems require multiple methods including both an initial hardness removal step and an ion exchange purification step. Indeed, many conventional systems require the initial hardness removal to reduce contaminants such as Ca²⁺ and Mg²⁺ down to a concentration of less than 20 parts per million (ppm). These conventional systems then require the ion exchange purification step to remove contaminants down to a concentration in the parts per billion (ppb) range (e.g., less than 50 ppb for all contaminants and less than 20 ppb for Ca²⁺ and Mg²⁺). The disclosed system and methods, however, improve over conventional systems, for example, by eliminating the initial hardness removal step. In these or other embodiments, the method 200 can utilize a single ion exchange purification to remove multivalent ion contaminants down to an acceptable level (e.g., less than 20-50 ppb) for the electrochemical salt-splitting process 212. The method 200 can remove the contaminants 208 with a single purification step at least in part because of the low contaminant concentration of the generated Na₂SO₄ solution 204 as described above with respect to FIG. 1. Indeed, in one or more implementations, a single purification step is able to reduce contaminant concentration to less than 200 ppb, less than 100 ppb, less than 50 ppb, less than 20 ppb, less than 15 ppb, less than 10 ppb, or less than 5 ppb. In other implementations, the nature of the battery manufacturing or recycling process may enable the electrochemical salt-splitting process to operate with less strict contaminant limits and may be able to tolerate up to 5 ppm of impurities.

In some embodiments, the methods of one or more embodiments can purify the Na₂SO₄ outlet streams (e.g., the Na₂SO₄ 204) with in-line ion-exchange columns similar to ion exchange processes described in Spanish Patent Application ES2056752A6 published on Oct. 1, 1994 and U.S. Pat. No. 4,707,347 granted on Nov. 17, 1987, both of which are incorporated herein by reference in their entirety. In other embodiments, the methods of one or more embodiments can utilize a cation exchange resin to absorb the Ni, Co, Mn, Al, and any other residual ionic metal impurities in the solution out of the solution before feeding the solution to the electrochemical salt-splitting device. As mentioned above, in one or more implementations, the methods of one or more embodiments can recycle the contaminants 208 (e.g., metal contaminants) back into a battery recycling process 222 as recycled metal feedstock.

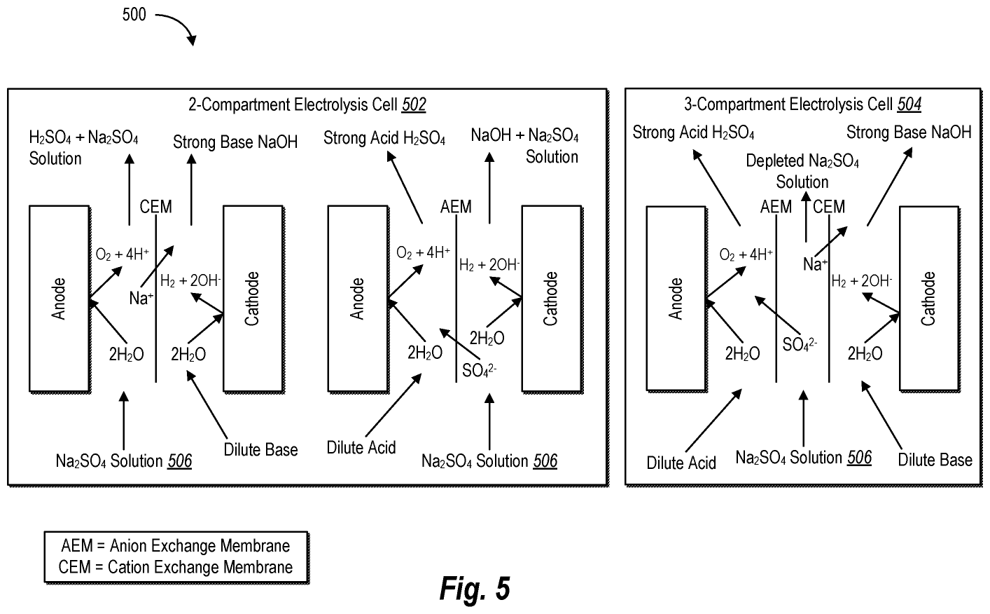

In one or more embodiments, the methods of one or more embodiments can further process the purified Na₂SO₄ solution 210 by converting the generated Na₂SO₄ to NaOH 218 and H₂SO₄ 220 via an electrochemical salt-splitting process 212. In some implementations, the electrochemical salt-splitting process 212 can include electrolysis 214 or bi-polar membrane electrodialysis 216. In one or more embodiments, the electrochemical device can include two or more compartments separated by ion-exchange membranes. Further, the electrochemical salt-splitting process 212 can utilize a membrane electrode design including stainless steel electrodes, nickel-plated steel electrodes, nickel electrodes, and/or a mixed-metal oxide electrodes in any combination. Alternatively, the electrochemical salt-splitting process 212 can utilize an electrode design that change the electrode half reactions from oxygen generation and/or hydrogen generation. For example, one or more implementations utilize a gas diffusion electrode. Further details of splitting the Na₂SO₄ of the purified Na₂SO₄ solution 210 into NaOH 218 and H₂SO₄ 220 using the electrochemical salt-splitting process 212 will be given with respect to FIGS. 5-10.

Furthermore, the methods of one or more embodiments recycle the generated NaOH 218 and/or H₂SO₄ 220 to the battery manufacturing process 202 to form a closed system. For example, whether utilizing electrolysis 214 or bi-polar membrane electrodialysis 216 for the electrochemical salt-splitting process 212, the methods of one or more embodiments can split the Na₂SO₄ of the purified Na₂SO₄ solution 210 to generate NaOH 218 and H₂SO₄ 220 as illustrated in FIG. 2. Further, the methods of one or more embodiments can recycle the generated NaOH 218 and H₂SO₄ 220 to the battery manufacturing process 202. Thus, the methods of one or more embodiments can be operated as a closed system with Na₂SO₄ generated from the battery manufacturing process 202 being incorporated into the method for converting the Na₂SO₄ to NaOH 218 and H₂SO₄ 220 and the NaOH 218 and H₂SO₄ 220 generated from splitting the Na₂SO₄ being incorporated into the battery manufacturing process 202. By forming a single closed system in a loop, the methods of one or more embodiments can achieve efficiencies that result in capital and cost savings. For example, by forming a closed system, the methods can avoid the need for a significant amount of equipment that would otherwise be needed to concentrate the H₂SO₄ to high concentrations. Beyond the elimination of impurity removal or concentration steps in the electrochemical salt-splitting process by controlling the impurities, other methods and embodiments can achieve efficiencies by adapting the battery manufacturing process to enable process intensification of the electrochemical process. One such embodiment would be to enable the selection of two compartment electrochemical cells, which are more efficient but produce impure acid or base, by modifying the battery manufacturing process to handle the impure acid or base. For example, modifications to the battery manufacturing process can include changing the recipe and operating conditions of the pCAM reactor process (concentrations, pH, temperature, residence time), or changing the conditions of the pCAM filtration process (amount of rinse solution, composition of rinse solution etc.).

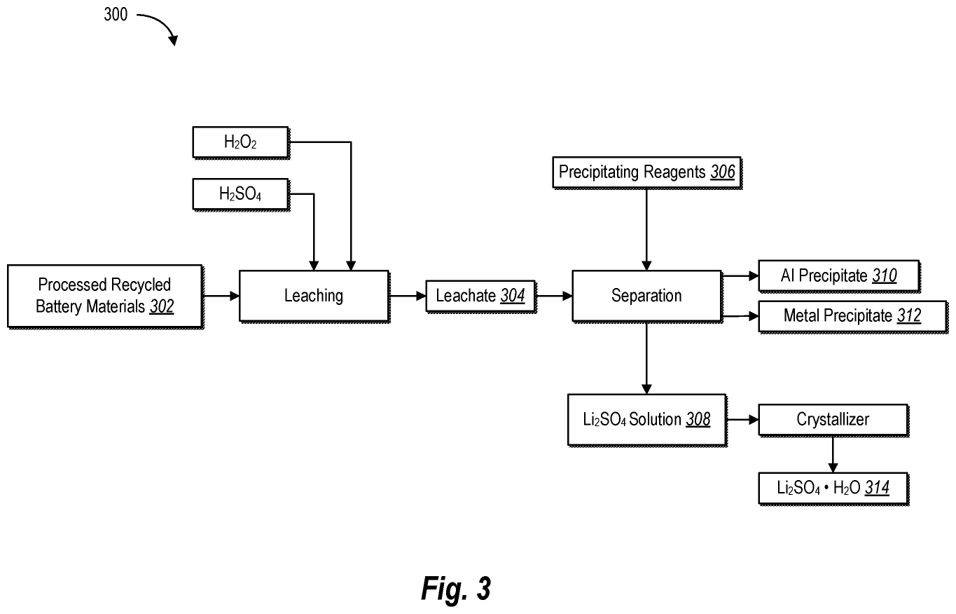

Reference is now made to FIG. 3 which illustrates a process diagram of a method 300 for generating lithium sulfate (Li₂SO₄) from a battery recycling process in accordance with one or more embodiments. For example, in one embodiment, the method 300 can extract Li₂SO₄, along with other valuable metals (e.g., Ni, Co, Mn, Al), from processed recycled battery materials 302 in a reductive leaching process with H₂SO₄ and hydrogen peroxide (H₂O₂). Some of the reactions are described by simplified chemical reaction Equations (2), (3) and (4) shown below.

MO₍ₛ₎+H₂SO_{4(aq)}→MSO_{4(aq)}+H₂O₍ₗ₎ (2)

Li₂O₍ₛ₎+H₂SO_{4(aq)}Li₂SO_{4(aq)}+H₂O₍ₗ₎ (3)

Al₂O₃₍ₛ₎+3H₂SO_{4(aq)}→Al₂(SO₄)_{3(aq)}+3H₂O₍ₗ₎ (4)

For Equation (2), metal oxide (MO) solids include metals (M) such as Ni, Co, and Mn, to name a few. Similarly, the resulting metal sulfate (MSO₄) in aqueous form includes corresponding metals, for instance, NiSO₄, CoSO₄, and MnSO₄, among others.

After the leaching process, the method 300 can separate the mixture of dissolved MSO₄, Li₂SO₄, and Al₂(SO₄)₃ in the leachate 304 into their components, for instance an Al precipitate 310, a metal precipitate 312, and Li₂SO₄ (e.g., from a Li₂SO₄ solution 308), with separation techniques involving crystallization, precipitation, solid-liquid separation, and size separation, among others. The metal precipitate 312 can include, but is not limited to, MSO₄, Al(OH)₃, and M(OH) 2 solids where metals (M) include Ni, Co, and Mn, to name a few. The method 300 can further crystallize out solid Li₂SO₄ as lithium sulfate monohydrate (Li₂SO₄·H₂O) 314 from the Li₂SO₄ solution 308 generated from the separation techniques. In one embodiment, the method 300 can produce a final Li₂SO₄·H₂O 314 that can be relatively pure and may have the composition as described below in Table 2.

TABLE 2
Approximate composition of the
lithium sulfate monohydrate (LSM).

| Element | Unit | Value |
|---|---|---|
| Li | wt % | 10.43 |
| Na | ppm | 100 |
| Ca | wt % | 0.5 |
| Mg | ppm | 1-200 |
| Al | ppm | 0 |
| Fe | ppm | 0 |
| Ni | ppm | 100 |
| Co | ppm | 0 |
| Cu | ppm | 0 |
| SO₄ | wt % | 75-76% |
| H₂O | wt % | 14.1-14.5% |

As shown in Table 2, the lithium weight percentage can be about 10.43 with theoretical limit of about 10.85 thereby implying an overall purity of Li₂SO₄ outlet stream of about 96% from lithium battery recycling. The residual sodium is a contaminant resulting from using city water, which the method 300 can remove or minimize by treating the water with reverse osmosis or by deionization. Calcium (Ca) and magnesium (Mg) are present as a result of the reagents the method 300 utilizes in the recycling process. The method 300 can remove Al, iron (Fe), Co, and copper (Cu) prior to chemical processing, with potential for some Ni carry-through to the Li₂SO₄H₂O 314 composition.

The remaining chemical elements such as sulfates (SO₄) may have a weight percentage in a range from about 75% to about 76%, with the theoretical limit at about 75% and the slight excess from impurities while most will exist as sulfates. The water (H₂O) may have a weight percentage in a range from about 14.1% to about 14.5% with the bulk of the water bound in the monohydrate with very little free water remaining.

In some implementations, the method 300 can produce a Li₂SO₄ product, such as the Li₂SO₄H₂O 314 or a Li₂SO₄ solution, with low contaminant concentrations. Indeed, the method 300 can generate a Li₂SO₄ solution wherein the concentration of at least some of the contaminants in the solution is less than 20 parts per million (ppm). The generated Li₂SO₄ solution can include various contaminants in aqueous ionic form such as nickel ions (Ni²⁺), cobalt ions (Co²⁺), copper ions (Cu²⁺), aluminum ions (Al³⁺), iron ions (Fe²⁺), calcium ions (Ca²⁺), magnesium ions (Mg²⁺), chlorine ions (Cl⁻), and/or fluorine ions (F⁻). In some implementations, the method 300 can include various methods to minimize the concentration of these contaminants in the Li₂SO₄ solution generated from the battery recycling process.

For example, methods for minimizing the concentration of contaminants in the generated Li₂SO₄ solution can include managing the inputs of the battery recycling process. For example, conventional battery manufacturing systems generally utilize water sourced from a municipality with minimal to no filtration of the water which can introduce various of the above-mentioned contaminants into product streams such as the Li₂SO₄ solution. For example, as mentioned above, using city water can introduce sodium into the system. The method 300 can minimize sodium in the Li₂SO₄ solution, however, by utilizing reverse osmosis water and/or deionized water, for example as the water used in the leaching process with H₂SO₄ and H₂O₂. The method 300 can further minimize other contaminants by ensuring that reagents, such as precipitating reagents 306, and feedstocks do not have the contaminants or have only trace amounts of contaminants. For example, the method 300 can utilize reagents and feedstocks that do not contain Ca²⁺ or Mg²⁺. Moreover, the method 300 can minimize F⁻ contamination by utilizing reagents that do not introduce F⁻ and utilizing battery feedstocks (e.g., battery scrap) that do not contain electrolytes, such as the processed recycled battery materials 302. Additionally, in some implementations, rather than using NaOH as a pH control, the method 300 can utilize the generated LiOH to control pH.

By minimizing the concentration of contaminants in the Li₂SO₄ solution in certain embodiments, the method 300 can minimize downstream purification techniques. For example, the method 300 can further process the generated Li₂SO₄ solution to generate LiOH and H₂SO₄. By minimizing the concentration in the Li₂SO₄ solution, the method 300 can eliminate certain downstream techniques that would normally be required to generate the LiOH and the H₂SO₄ from the Li₂SO₄ solution as discussed in further detail below.

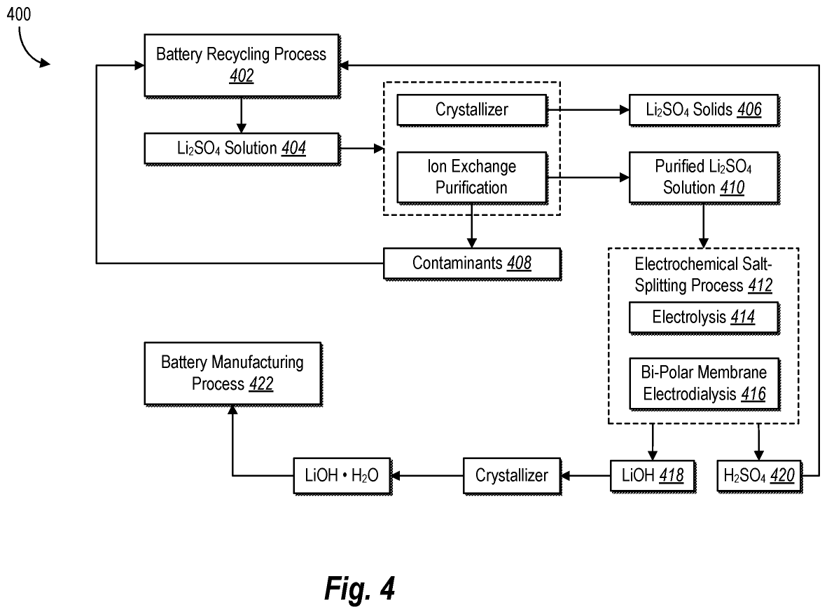

As mentioned above, in some embodiments, the method 300 can further process Li₂SO₄ in its solution form (e.g., a Li₂SO₄ solution 404) generated from a battery recycling process 402. For instance, FIG. 4 illustrates a process diagram of a method 400 for converting Li₂SO₄ to LiOH 418 and H₂SO₄ 420 via an electrochemical salt-splitting process 412 in accordance with one or more embodiments. The method 400 can comprise various intermediate methods for processing the Li₂SO₄ solution 404 prior to subjecting the Li₂SO₄ solution 404 to an electrochemical salt-splitting process 412 as shown in FIG. 4. For example, in various embodiments, the method 400 can include intermediate processing methods such as processing the Li₂SO₄ solution 404 through a crystallizer and/or purifying contaminants 408 from the Li₂SO₄ solution 404 by ion exchange purification.

For instance, in one or more implementations, the method 400 can further process the Li₂SO₄ solution 404 through a crystallizer to produce anhydrous lithium sulfate solids. Moreover, in some embodiments, the Li₂SO₄ solution 404 may include contaminants 408 which the method 400 can further process through ion exchange methods as discussed in further detail below. Indeed, the Li₂SO₄ solution 404 can include contaminants 408, such as metal contaminants in aqueous ionic form, e.g., Ni²⁺, Co²⁺, Al³⁺ and/or other contaminants such as chlorine and fluorine ions (e.g., Cl⁻ and F⁻). In some embodiments, the method 400 can subject the Li₂SO₄ solution 404 to crystallizer processing to generate anhydrous lithium sulfate (Li₂SO₄) solids 406. The method 400 can similarly produce the metals, including chorine and fluorine contaminants, in the Li₂SO₄ solids 406, in their solid ionic form as part of the Li₂SO₄ solid crystal structure. In some embodiments, the method 400 can extract and recycle the solid ionic forms back into the battery recycling process 402. Indeed, by being located within a single combined plant, these processes can be directly interconnected to provide process intensification.

While the Li₂SO₄·H₂O may have the composition as shown above, it will be appreciated by one skilled in the art that the Li₂SO₄H₂O can have other compositions or concentrations depending on the processing steps.

Moreover, in some implementations, the method 400 can crystallize the LiOH utilizing a single-stage crystallization. Indeed, in these or other embodiments, the method 400 can eliminate the need for multiple-stage crystallization by minimizing the sodium content in the feedstock (e.g., the Li₂SO₄ solution 404). For instance, the method 400 can limit sodium content by utilizing the LiOH 418 generated from an electrochemical salt-splitting process 412, as described in further detail below, as a pH control rather than using NaOH. Further, in some instances the method 400 can use LiOH to replace lime to form a metal precipitate. In further instances, the LiOH can be combined with CO₂ to form a Li₂CO₃ solution that can be used instead of Na₂CO₃ as part of an impurity removal step. Moreover, as discussed above with respect to the methods for generating the Li₂SO₄ from a battery recycling process in regard to FIG. 3, the method 400 can minimize sodium by utilizing reverse osmosis and/or deionized water in the intermediate purification methods prior to the electrochemical salt-splitting process 412. Also, the method 400 can utilize reagents that do not introduce sodium, specifically by substituting CO₂ for Na₂CO₃ in processes including a multi-valent cation removal step prior to salt-splitting, using lime in place of caustic soda in precipitation steps during optional pre-salt-splitting purification steps, and using electrochemical processes rather than chemical processes where possible. Furthermore, the method 400 may utilizes battery feedstocks (e.g., battery scrap in the battery recycling process 402) that do not include sodium. Additionally, in one or more embodiments, the method 400 can include a bleed to manage impurity build up as discussed in further detail below.

As mentioned above, in some embodiments, prior to subjecting the Li₂SO₄ solution 404 to an electrochemical salt-splitting process 412 to generate the LiOH 418 and the H₂SO₄ 420, the method 400 can further purify the contaminants 408 from the Li₂SO₄ solution 404. As noted above, electrochemical devices are sensitive to metal impurities, residual metals in solution streams can poison membranes and electrodes, which can increase cell resistance and decrease performance. Because of this, many salt-splitting systems need feedstock to be pure which requires extra purification steps to remove residual metals. Accordingly, in some embodiments, the methods of one or more embodiments can ensure that the Li₂SO₄ solution 404 is sufficiently pure to use in the electrochemical salt-splitting process 412 without extensive purification steps. For example, the methods of one or more embodiments can purify the Li₂SO₄ solution 404 with in-line ion exchange columns or a cation exchange resin as described with respect to purification of the Na₂SO₄ solution and FIG. 2.

Further, the methods of one or more embodiments can utilize a single purification step, for instance, ion exchange purification to remove the contaminants 408 from the Li₂SO₄ solution 404 similar to the ion exchange purification methods described above with respect to the Na₂SO₄ solution and FIG. 2. Indeed, the methods of one or more embodiments can utilize similar methods for the Li₂SO₄ solution 404 at least in part because of the minimal concentration of contaminants 408 within the Li₂SO₄ generated from the battery recycling process as described above with respect to FIG. 3.

As mentioned above, in some embodiments, the methods of one or more embodiments can convert the Li₂SO₄ generated from the battery recycling process 402 in the purified Li₂SO₄ solution 410 to the LiOH 418 and the H₂SO₄ 420 via an electrochemical salt-splitting process 412. Moreover, the methods of one or more embodiments can utilize the same methods and devices for converting the Li₂SO₄ of the purified Li₂SO₄ solution 410 to the LiOH 418 and the H₂SO₄ 420 as described above for converting Na₂SO₄ to NaOH and H₂SO₄ with respect to FIG. 2. Indeed, further details regarding some of the methods and devices will be discussed with respect to FIGS. 5-10.

Additionally, in one or more embodiments, the method 400 can include generating the Li₂SO₄ from the battery recycling process and converting the generated Li₂SO₄ to the LiOH 418 and the H₂SO₄ 420 in a closed system at least by recycling the H₂SO₄ 420 to the battery recycling process. For example, as illustrated in FIG. 4, whether utilizing electrolysis 414 or bi-polar membrane electrodialysis 416 for the electrochemical salt-splitting process 412, the method 400 can split the Li₂SO₄ of the purified Li₂SO₄ solution 410 to generate the LiOH 418 (e.g., in a LiOH solution) and the H₂SO₄ 420 (e.g., in solution). Indeed, the method 400 can operate as a closed system by incorporating the Li₂SO₄ generated from the battery recycling process 402 into the method for converting the Li₂SO₄ to the LiOH 418 and the H₂SO₄ 420 and recirculating the H₂SO₄ 420 back into the process for generating the Li₂SO₄. For example, the H₂SO₄ 420 can be recirculated back into the process of leaching the processed recycled battery materials 302. Furthermore, the method 400 can recirculate the generated LiOH 418 (e.g., as a LiOH solution) back into the battery recycling process 402 or the battery manufacturing process 422. Indeed, a LiOH solution containing the LiOH 418 can be sent to a crystallizer to generate LiOH H₂O solids, which can be sold or sent to the battery manufacturing process 422. Beyond the elimination of impurity removal or concentration steps in the electrochemical salt-splitting process by controlling the impurities, other methods and embodiments can achieve efficiencies by adapting the battery recycling process to enable process intensification of the electrochemical process. One such embodiment would be to enable the selection of two compartment electrochemical cells, which are more efficient but produce impure acid or base, by modifying the battery recycling process to handle the impure acid or base. Additionally, modifications to the battery recycling process can include one or more of (1) changing the location at which the acid is recycled back into the battery recycling process, (2) reducing water and purchased acid (or base) addition to accommodate the impure acid (or base), or (3) controlling the conditions in both salt-splitting and battery recycling to avoid the undesired saturation of any part of the system with Li₂SO₄, which would result in crystallization of Li₂SO₄, leading to product losses and operational issues.

Further, in some implementations, the method 400 of generating the Li₂SO₄ from the battery recycling process and converting the generated Li₂SO₄ to the LiOH 418 and the H₂SO₄ 420 in a closed system can include removing impurity build-up through a bleed. For example, in a closed or closed-loop system, trace concentrations of impurities can build over time causing inefficiencies and degradation of system fixtures and equipment as well as product quality degradation. In one or more embodiments, the method 400 can further include recovery of valuable materials within the bleed stream, such as generating lithium carbonate (Li₂CO₃) from the bleed stream to maximize recovery of the Li⁺. In these or other embodiments, the method 400 can utilize CO₂ and LiOH in the bleed stream to avoid addition of Na⁺ through addition of Na₂CO₃. Moreover, the bleed stream can be processed in a zero-liquid discharge evaporator for water recovery.

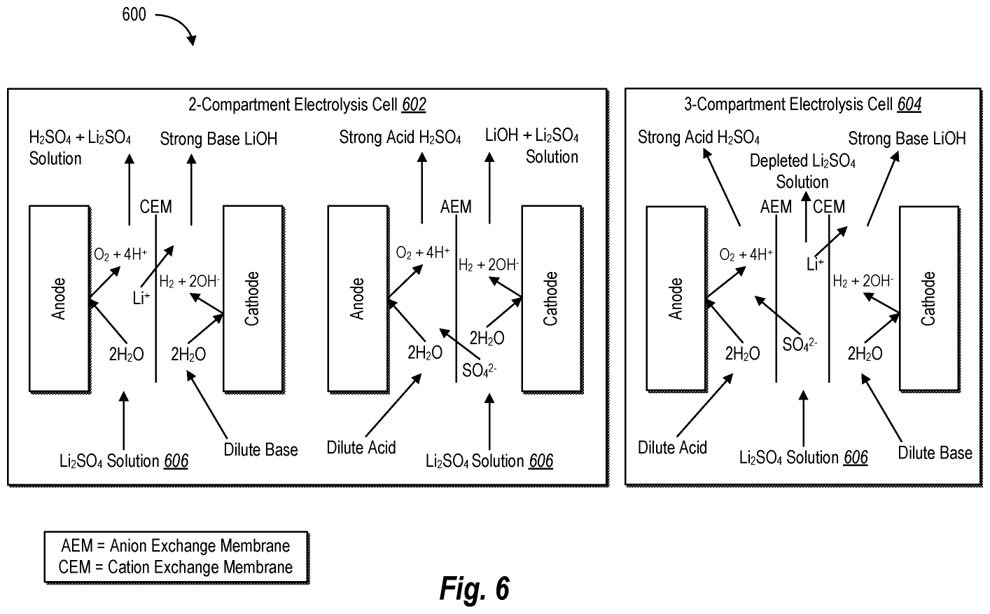

Reference is now made to FIG. 5 showing a method 500 for conversion of Na₂SO₄ from, for example, the Na₂SO₄ outlet stream generated in FIG. 1 or the purified Na₂SO₄ solution of FIG. 2, to NaOH and H₂SO₄ via an electrolysis salt-splitting process using two-compartment electrolysis cells 502 and three-compartment electrolysis cells 504. Similarly, FIG. 6 shows a process 600 for conversion of Li₂SO₄ from, for example, the Li₂SO₄ outlet stream generated in FIG. 2 or the purified Li₂SO₄ solution of FIG. 4, to LiOH and H₂SO₄ via an electrolysis salt-splitting process using the two-compartment electrolysis cell 602 and the three-compartment electrolysis cell 604.

In general, the two conversions shown in FIGS. 5 and 6 are substantially similar with the difference being the initial chemical solutions being Na₂SO₄ and Li₂SO₄, respectively, and the resulting products being NaOH and LiOH, respectively. Both conversions can produce H₂SO₄.

As shown in FIGS. 5 and 6, with the three-compartment electrolysis cell 504, the methods of one or more embodiments can include both anion and cation exchange membranes. Depending on the properties, these membranes can be semi-permeable to allow transportation of specific ions (e.g., anions or cations) across the membranes. With the two-compartment electrolysis cell 502, the methods of one or more embodiments can utilize either a cation or anion exchange membrane.

In the three-compartment electrolysis cell 504, the methods of one or more embodiments can include providing Na₂SO₄ solution 506 to the central compartment between the anion and cation exchange membranes (right side of FIG. 5). Under an applied potential, sodium ions (Nat) can migrate through the cation exchange membrane (CEM) to the cathode compartment, while sulfate ions (SO₄²⁻) can migrate through the anion exchange membrane (AEM) to the anode compartment. Through the anode and cathode reactions, the methods of one or more embodiments can generate H⁺ and OH⁻ via water oxidation and reduction, respectively. The reactions are described as in Equations (5) and (6).

Anode: 2H₂O→O₂+4H⁺+4e⁻ (5)

Cathode: 4H₂O+4e⁻→2H₂+4OH⁻ (6)

In the anode compartment, H⁺ combine with SO₄²⁻ to produce H₂SO₄, while in the cathode compartment, OH⁻ combine with Na⁺ to produce NaOH. In some embodiments, the methods of one or more embodiments can utilize other electrochemical reactions besides water oxidation and reduction to generate H⁺ at the anode and OH⁻ at the cathode. For example, one or more implementations include utilizing oxygen-depolarized cathode and hydrogen-depolarized anode variants.

In the two-compartment electrolysis cell 502 with a CEM, the methods of one or more embodiments can include providing Na₂SO₄ solution 506 to the anode compartment. Similarly, under an applied potential, Na⁺ can migrate through the CEM to the cathode compartment where Na⁺ combine with generated OH⁻ to produce NaOH. In the anode compartment, SO₄²⁻ combine with generated H⁺ to produce H₂SO₄.

In the two-compartment electrolysis cell 502 with an AEM, the methods of one or more embodiments can include providing Na₂SO₄ solution 506 to the cathode compartment. Similarly, under an applied potential, SO₄²⁻ can migrate through the AEM to the anode compartment where SO₄²⁻ combine with generated H⁺ to produce H₂SO₄. In the cathode compartment, Na combine with generated OH⁻ to produce NaOH.

As mentioned above, in some embodiments, the method can convert the Na₂SO₄ solution 506, generated from the outlet stream of the battery manufacturing process, to NaOH and H₂SO₄ via an electrochemical salt-splitting process, using either two- or three-compartment electrolysis cells 502-504 as described above. Further, as mentioned above, the methods of one or more embodiments can return the resulting NaOH to a process for producing of precursor cathode active materials (pCAM) (see Equation (1)), and the H₂SO₄ to a battery recycling process (see Equations (2), (3) and (4)) such that electrochemical salt-splitting allows for closed loop processing on battery recycling and manufacturing. In other words, the system generates Na₂SO₄ and converts it to NaOH and H₂SO₄ in a closed-loop battery recycling and manufacturing system such that the Na₂SO₄ outlet stream generated from the battery manufacturing process feeds into the process for converting Na₂SO₄ to NaOH and H₂SO₄ and the NaOH and H₂SO₄ from the conversion process feeds into the battery manufacturing process.

For Li₂SO₄ salt-splitting process in FIG. 6, the methods of one or more embodiments can utilize similar processes for both the two- and three-compartment electrolysis cells as described above for the Na₂SO₄ salt-splitting process as described above with respect to FIG. 5 by replacing Na₂SO₄ with Li₂SO₄ and therefore will not be elaborated further herein. However, in this instance, the system generates LiOH on the cathode side instead of NaOH, while still generating H₂SO₄ on the anode side.

In some embodiments, the methods of one or more embodiments can convert the Li₂SO₄ solution 606, generated from the outlet stream of the battery recycling process, to LiOH and H₂SO₄ via an electrochemical salt-splitting process, using a two-compartment electrolysis cell 602, a three-compartment electrolysis cell 604 as described above, or an electrochemical cell with more than three compartments. In still further implementations, the methods of one or more embodiments can further process and calcine the resulting LiOH with M(OH)₂ to produce lithium-rich cathode active materials (CAM), while reusing the H₂SO₄ in the battery recycling process (see Equations (2), (3) and (4)) such that electrochemical salt-splitting allows for closed loop processing on battery recycling and manufacturing. In other words, a method of one or more embodiments generates Li₂SO₄ and converts it to LiOH and H₂SO₄ in a closed-loop battery recycling and manufacturing system such that the Li₂SO₄ outlet stream generated from the battery recycling process feeds into the process for converting Li₂SO₄ to LiOH and H₂SO₄ and the LiOH and H₂SO₄ from the conversion process feeds into the battery recycling process and/or a battery manufacturing process.

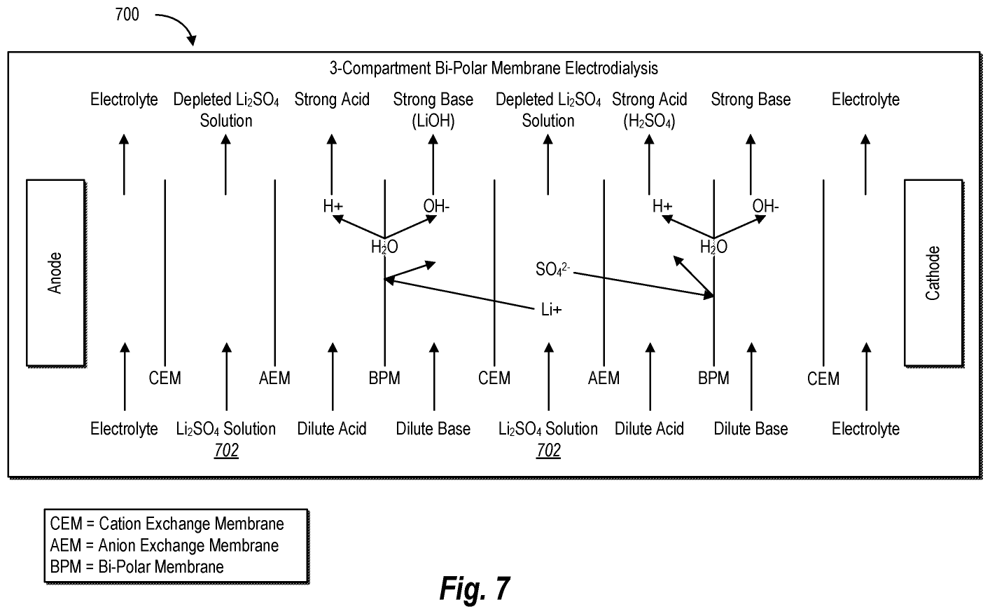

Furthermore, in some embodiments, the methods of one or more embodiments can utilize bi-polar membrane electrodialysis as the salt-splitting process as mentioned above. For example, FIG. 7 illustrates a method 700a for conversion of Li₂SO₄ to LiOH and H₂SO₄ via a salt-splitting process using bi-polar membrane electrodialysis in accordance with one or more embodiments. Indeed, FIG. 7 shows conversion of Li₂SO₄ from, for example, the Li₂SO₄ outlet stream generated in FIG. 4 or the purified Li₂SO₄ solution of FIG. 4, to LiOH and H₂SO₄ via a salt-splitting process using bi-polar membrane electrodialysis.

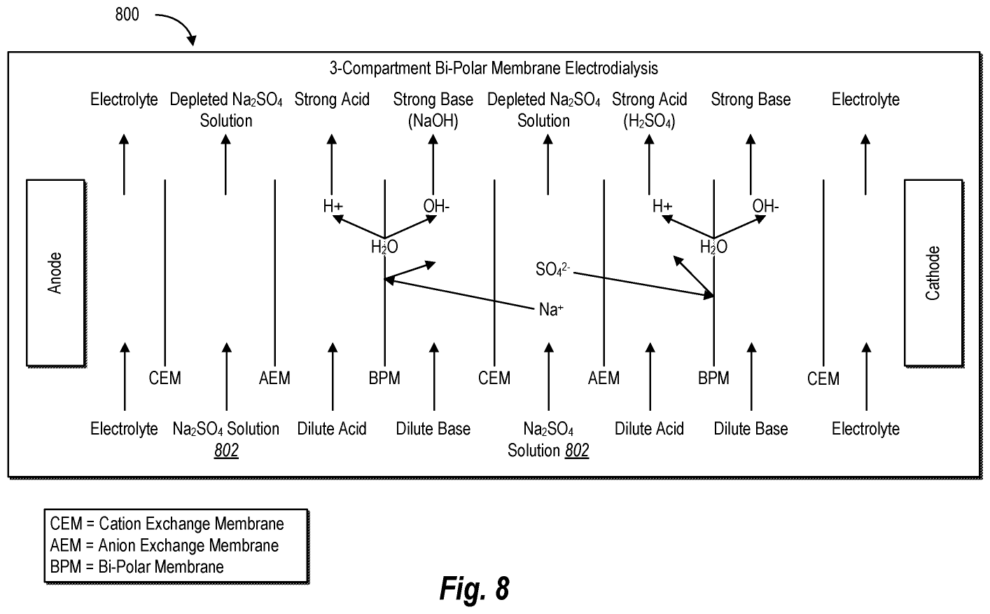

As shown in FIG. 7, in one or more embodiments, the methods of one or more embodiments can utilize an electrodialysis cell including an anode and a cathode separated by multiple membranes defining a plurality of compartments. For example, FIG. 7 illustrates a bi-polar membrane electrodialysis system including an anode followed by a series of membranes, for example, a CEM, an AEM, a bi-polar exchange membrane (BPM), a second CEM, a second AEM, a second BPM, and a third CEM followed by the cathode. Further, as illustrated in FIG. 7, the system bi-polar membrane electrodialysis includes a compartment between each membrane, between the anode and the first CEM, and between the cathode and the third CEM. Depending on the properties, the CEM's and the AEM's can be semi-permeable to allow transportation of specific ions (e.g., anions or cations) across the membranes. As shown, the bi-polar membrane electrodialysis systems of FIGS. 7 and 8 include two cells each with three compartments. In alternative implementations, the bi-polar membrane electrodialysis system includes two, three, or more compartments per cell. In further implementations, the bi-polar membrane electrodialysis system can comprise any non-zero number of cells.

In some implementations, a method of utilizing the electrodialysis cells described above can include providing an electrolyte, the Li₂SO₄ solution 702, a dilute acid, and a dilute base into the compartments of the cell to produce a strong base (e.g., LiOH) and a strong acid (e.g., H₂SO₄). For instance, the method can include providing an electrolyte into the compartments between the end electrodes and a CEM. Further, the method can include providing the Li₂SO₄ solution 702 to the compartments between a CEM and an AEM, the dilute acid to the compartments between an AEM and a BPM, and the dilute base to the compartments between a BPM and a CEM. Under an applied potential and/or current, Li⁺ can migrate from the Li₂SO₄ solution compartments through the CEMs to the adjacent base compartments and the SO₄²⁻ can migrate from the Li₂SO₄ solution compartments through the AEMs to the adjacent acid compartments. Through the BPM reactions, which are driven by the applied potential and/or current, the system can generate H⁺ and OH⁻ from water via ion transfer. Each BPM can include a cation-exchange layer (CEL) and an anion exchange layer (AEL). The reaction is described as in Equation (7).

H₂O→H⁺+OH⁻ (7)

The AEL prevents the Li⁺ from migrating across each BPM while allowing OH⁻ to enter the base compartments. The CEL prevents the SO₄²⁻ from migrating through each BPM while allowing the produced H⁺ to enter the acid compartments. In the base compartments, the OH⁻ combine with Li⁺ to produce LiOH and in the acid compartments, the H⁺ combine with SO₄²⁻ to produce H₂SO₄. Furthermore, one will appreciate of the disclosure herein, while not shown in the figures, that all CEMs can have Li⁺ travelling across them and all AEMs can have SO₄²⁻ travelling across them. In some implementations, the method can include using other arrangements of membranes within the electrodialysis cell to achieve the electrochemical salt-splitting as will be understood by a person having ordinary skill in the art.

Additionally, FIG. 8 illustrates a method 802 for conversion of Na₂SO₄ to NaOH and H₂SO₄ via a salt-splitting process using bi-polar membrane electrodialysis in accordance with one or more embodiments. Indeed, FIG. 8 shows conversion of Na₂SO₄ from, for example, the Na₂SO₄ outlet stream generated in FIG. 2 or the purified Na₂SO₄ solution of FIG. 2, to NaOH and H₂SO₄ via a salt-splitting process using bi-polar membrane electrodialysis.

As shown in FIG. 8, in one or more embodiments, the methods of one or more embodiments can utilize an electrodialysis cell including an anode and a cathode separated by multiple membranes defining a plurality of compartments. For example, FIG. 8 illustrates a bi-polar membrane electrodialysis system including an anode followed by a series of membranes, for example, a CEM, an AEM, a bi-polar exchange membrane (BPM), a second CEM, a second AEM, a second BPM, and a third CEM followed by the cathode. Further, as illustrated in FIG. 8, the system bi-polar membrane electrodialysis includes a compartment between each membrane, between the anode and the first CEM, and between the cathode and the third CEM. Depending on the properties, the CEM's and the AEM's can be semi-permeable to allow transportation of specific ions (e.g., anions or cations) across the membranes.

In some implementations, a method of utilizing the electrodialysis cells described above can include providing an electrolyte, the Na₂SO₄ solution 702b, a dilute acid, and a dilute base into the compartments of the cell to produce a strong base (e.g., NaOH) and a strong acid (e.g., H₂SO₄). For instance, the method can include providing an electrolyte into the compartment between the anode and the first CEM and the compartment between the cathode and the third CEM. Further, the method can include providing the Na₂SO₄ solution 702b to the compartments between a CEM and an AEM, the dilute acid to the compartments between an AEM and a BPM, and the dilute base to the compartments between a BPM and a CEM. Under an applied potential, Na can migrate through the second CEM to the compartment between the first BPM and the second CEM, and the SO₄²⁻ can migrate through the second AEM to the compartment between the second AEM and the second BPM. Through the BPM reactions, the system can generate H⁺ and OH⁻ via water oxidation and reduction. Each BPM can include a cation-exchange layer (CEL) and an anion exchange layer (AEL).

The AEL of the first BPM prevents the Na from migrating through the first BPM and the CEL of the second BPM prevents the SO₄²⁻ from migrating through the second BPM. In the compartment between the first BPM and the second CEM, the OH⁻ combine with Na to produce NaOH and in the compartment between the second AEM and the second BPM, the IV combine with SO₄²⁻ to produce H₂SO₄. In some embodiments, the method can utilize other electrochemical reactions besides water oxidation and reduction to generate H⁺ and OH⁻ at the BPMs. Furthermore, one will appreciate, while not shown in the figures, that all CEMs can have Na travelling across them and all AEMs can have SO₄²⁻ travelling across them.

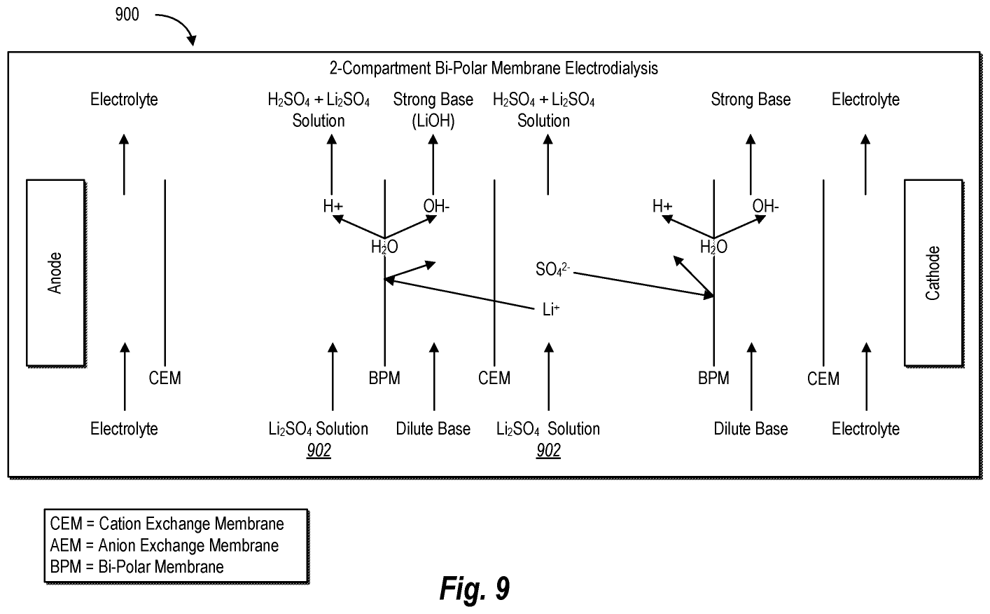

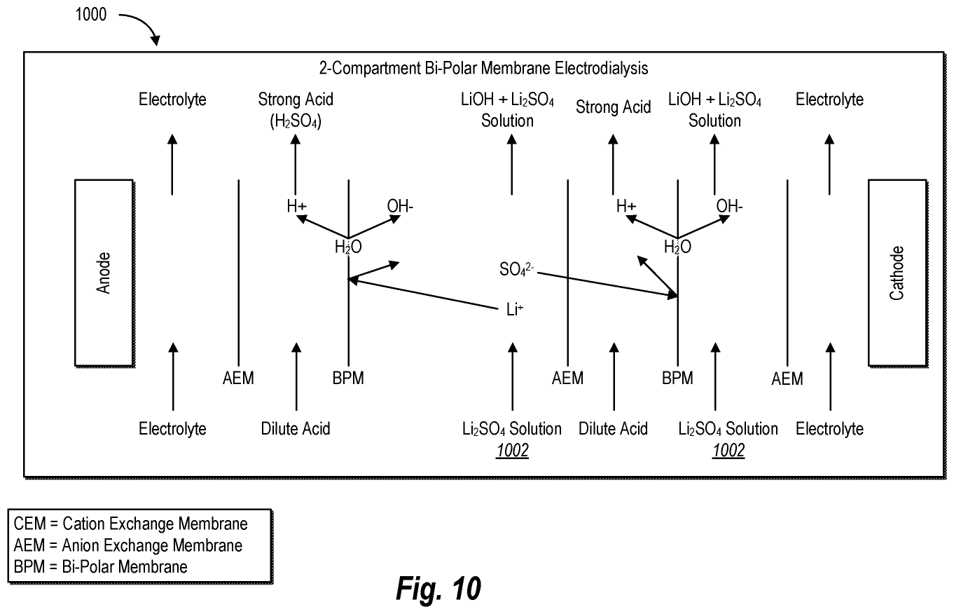

In some implementations, the method can include using other arrangements of membranes within the electrodialysis cell to achieve the electrochemical salt-splitting as will be understood by a person having ordinary skill in the art. For example, FIGS. 9 and 10 illustrate conversion of Li₂SO₄ to LiOH and H₂SO₄ via a salt-splitting process using bi-polar membrane electrodialysis cells with two compartments in accordance with one or more embodiments. Two-compartment bi-polar electrodialysis functions similarly to three-compartment, except the central salt compartments are combined with either the acid or base compartments.

For example, in the two-compartment bi-polar electrodialysis cell system 900 with a CEM, the methods of one or more embodiments can include providing Li₂SO₄ solution 902 to the acid compartments. Under an applied potential, Li⁺ can migrate through the CEM to the base compartments where Li⁺ combine with generated OH⁻ to produce LiOH. In the acid compartments, SO₄²⁻ combines with generated H⁺ to produce H₂SO₄. A mixture of Li₂SO₄ solution and H₂SO₄ leaves the acid compartments. A pure stream of LiOH solution leaves the base compartments.

In the two-compartment bi-polar electrodialysis cell 1000 with an AEM, the methods of one or more embodiments can include providing Li₂SO₄ solution 1002 to the base compartments. Similarly, under an applied potential, SO₄²⁻ can migrate through the AEM to the acid compartments where SO₄²⁻ combine with generated H⁺ to produce H₂SO₄. In the base compartments, Li⁺ combine with generated OH⁻ to produce LiOH. A mixture of Li₂SO₄ solution and LiOH leaves the base compartments. A pure stream of H₂SO₄ solution leaves the acid compartments.

While FIGS. 9 and 10 illustrate two-compartment bi-polar electrodialysis cell systems 900 and 1000 for converting Li₂SO₄ to LiOH and H₂SO₄, it will be apparent to a person having ordinary skill in the art that similar systems can be utilized for Na₂SO₄ conversion to NaOH and H₂SO₄. For example, the methods of one or more implementations can include providing Na₂SO₄ solution in place of the Li₂SO₄ solution to systems 900 and 1000 to generate NaOH and H₂SO₄ via similar mechanisms described above with respect to FIGS. 9 and 10.

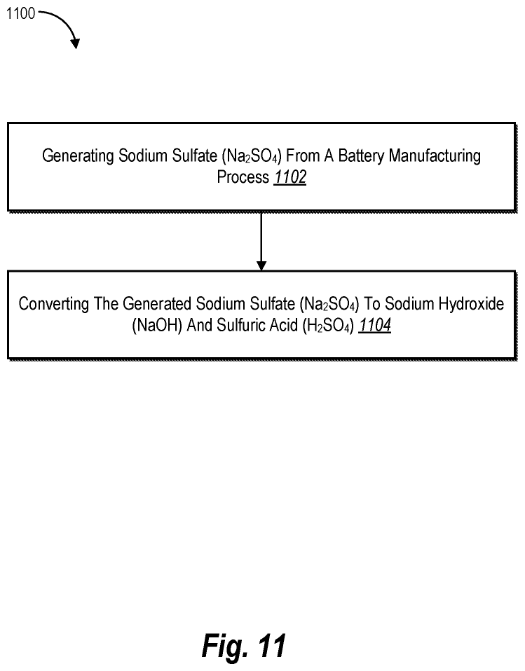

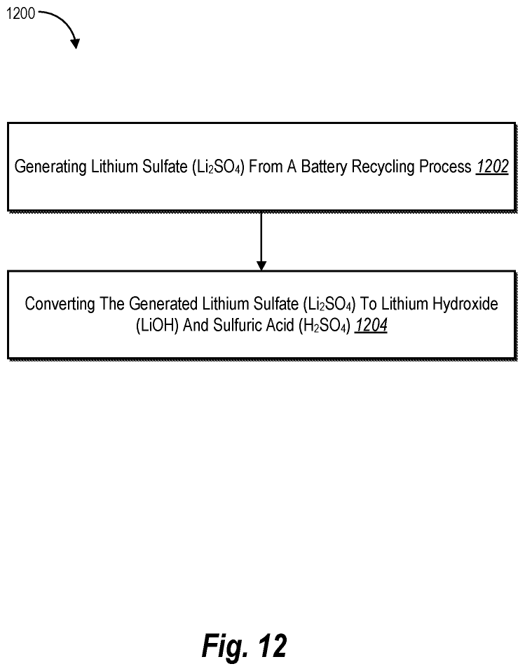

FIGS. 1-10, the corresponding text, and the examples provide a number of different systems and methods for generating Na₂SO₄ and Li₂SO₄ from battery manufacturing processes and battery recycling processes, respectively, and converting the Na₂SO₄ and Li₂SO₄ to NaOH and LiOH, respectively, in combination with H₂SO₄. In addition to the foregoing, embodiments can also be described in terms of flowcharts comprising acts for accomplishing a particular result. For example, FIGS. 11 and 12 illustrate flowcharts of example sequences of acts in accordance with one or more embodiments.

While FIGS. 11 and 12 illustrates acts according to some embodiments, alternative embodiments may omit, add to, reorder, and/or modify any of the acts shown in FIGS. 11 and 12. The acts of FIGS. 11 and 12 can be performed as part of a method. Alternatively, a system can perform the acts of FIGS. 11 and 12. Additionally, the acts described herein may be repeated or performed in parallel with one another or in parallel with different instances of the same or other similar acts.

FIG. 11 illustrates an example series of acts 1100 for generating Na₂SO₄ from a battery manufacturing process and converting the Na₂SO₄ to NaOH and H₂SO₄. The series of acts 1100 can include an act 1102 of generating sodium sulfate (Na₂SO₄) from a battery manufacturing process; and an act 1104 of converting the generated sodium sulfate Na₂SO₄) to sodium hydroxide (NaOH) and sulfuric acid (H₂SO₄).

For example, in one or more embodiments, the series of acts 1100 can include generating sodium sulfate (Na₂SO₄) from a battery manufacturing process; and converting the generated sodium sulfate (Na₂SO₄) to sodium hydroxide (NaOH) and sulfuric acid (H₂SO₄) via an electrochemical salt-splitting process.

In one or more implementations, the electrochemical salt-splitting process comprises one of electrolysis or bi-polar membrane electrodialysis.

Moreover, in some embodiments, the electrochemical salt-splitting process utilizes a membrane electrode design comprising at least one of a stainless-steel electrode, a nickel-plated steel electrode, a nickel electrode, or a mixed-metal oxide electrode.

In addition, in some implementations, the electrochemical salt-splitting process utilizes a membrane electrode design that change the electrode half reactions from oxygen generation and/or hydrogen generation. More specifically, in one or more implementations, the electrode design comprises a gas diffusion electrode.

Furthermore, in some embodiments, generating the sodium sulfate (Na₂SO₄) from the battery manufacturing process comprises generating a sodium sulfate solution wherein a concentration of a contaminant in the sodium sulfate solution is less than 20 parts per million (ppm).

In some implementations, the contaminant comprises one of nickel ions (Ni2+), cobalt ions (Co2+), manganese ions (Mn2+), aluminum ions (A13+), potassium ions (K+), calcium ions (Ca2+), magnesium ions (Mg2+), chlorine ions (Cl—), or fluorine ions (F—).

Moreover, in some embodiments, converting the generated sodium sulfate (Na₂SO₄) to the sodium hydroxide (NaOH) and the sulfuric acid (H₂SO₄) comprises removing the contaminants from the sodium sulfate solution utilizing a single ion exchange purification.

In addition, in some implementations, the series of acts 1100 can include recycling at least one of the sodium hydroxide (NaOH) or the sulfuric acid (H₂SO₄) to the battery manufacturing process to form a closed system.

FIG. 12 illustrates an example series of acts 1200 for generating Li₂SO₄ from a battery recycling process and converting the Li₂SO₄ to LiOH and H₂SO₄. The series of acts 1200 can include an act 1202 of generating lithium sulfate (Li₂SO₄) from a battery recycling process; and an act 1204 of converting the generated lithium sulfate (Li₂SO₄) to lithium hydroxide (LiOH) and sulfuric acid (H₂SO₄).

Furthermore, in some embodiments, the series of acts 1200 can include generating lithium sulfate (Li₂SO₄) from a battery recycling process; and converting the generated lithium sulfate (Li₂SO₄) to lithium hydroxide (LiOH) and sulfuric acid (H₂SO₄) via an electrochemical salt-splitting process.

In one or more implementations, the electrochemical salt-splitting process comprises one of electrolysis or bi-polar membrane electrodialysis.

Moreover, in some embodiments, the electrochemical salt-splitting process utilizes an electrochemical electrode design comprising at least one of a stainless-steel electrode, a nickel-plated steel electrode, a nickel electrode, or a mixed-metal oxide electrode.

In addition, in some implementations, the electrochemical salt-splitting process utilizes that change the electrode half reactions from oxygen generation and/or hydrogen generation. More specifically, in one or more implementations, the electrode design comprises a gas diffusion electrode.

Furthermore, in some embodiments, generating the lithium sulfate (Li₂SO₄) from the battery recycling process comprises leaching recycled battery materials with a leaching solution comprised of sulfuric acid (H₂SO₄), hydrogen peroxide (H₂O₂), and at least one of deionized water or reverse osmosis water.

In some implementations, generating the lithium sulfate (Li₂SO₄) from the battery recycling process comprises generating a lithium sulfate solution wherein a concentration of a contaminant in the lithium sulfate solution is less than 20 parts per million (ppm).

Moreover, in some embodiments, the contaminant comprises one of nickel ions (Ni²⁺), cobalt ions (Co²⁺), copper ions (Cu²⁺), aluminum ions (Al³⁺), iron ions (Fe²⁺), calcium ions (Ca²⁺), magnesium ions (Mg²⁺), chlorine ions (Cl⁻), or fluorine ions (F⁻).

In addition, in some implementations, generating the lithium sulfate solution comprises restricting battery feedstocks of the battery recycling process to at least one of battery scrap that does not contain electrolyte or battery cells that use electrolyte that does not contain fluorine.

Furthermore, in some embodiments, converting the generated lithium sulfate (Li₂SO₄) to the lithium hydroxide (LiOH) and the sulfuric acid (H₂SO₄) comprises removing, utilizing a single ion exchange purification, the contaminant from the lithium sulfate solution.

In one or more implementations, converting the generated lithium sulfate (Li₂SO₄) to the lithium hydroxide (LiOH) and the sulfuric acid (H₂SO₄) comprises crystallizing the lithium hydroxide (LiOH) utilizing a single-stage crystallization.

Moreover, in some embodiments, generating the lithium sulfate (Li₂SO₄) from the battery recycling process and converting the generated lithium sulfate (Li₂SO₄) to the lithium hydroxide (LiOH) and the sulfuric acid (H₂SO₄) is carried out in a closed system by recycling the sulfuric acid (H₂SO₄) to the battery recycling process.

In addition, in some implementations, the series of acts 1200 can include recirculating the generated lithium hydroxide (LiOH) back into at least one of the battery recycling process or a battery manufacturing process.

While example embodiments have been particularly shown and described, it will be understood by those skilled in the art that various changes in form and details may be made therein without departing from the scope of the embodiments encompassed by the appended claims. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

What is claimed is:

1. A method comprising:
generating sodium sulfate (Na₂SO₄) from a battery manufacturing process; and
converting the generated sodium sulfate (Na₂SO₄) to sodium hydroxide (NaOH) and sulfuric acid (H₂SO₄) via an electrochemical salt-splitting process.

2. The method of claim 1, wherein the electrochemical salt-splitting process comprises one of electrolysis or bi-polar membrane electrodialysis.

3. The method of claim 2, wherein the electrochemical salt-splitting process utilizes a membrane electrode design comprising at least one of a stainless-steel electrode, a nickel-plated steel electrode, a nickel electrode, or a mixed-metal oxide electrode.

4. The method of claim 2, wherein the electrochemical salt-splitting process utilizes a electrode design that change electrode half reactions from oxygen generation or hydrogen generation.

5. The method of claim 1, wherein generating the sodium sulfate (Na₂SO₄) from the battery manufacturing process comprises generating a sodium sulfate solution wherein a concentration of a contaminant in the sodium sulfate solution is less than 20 parts per million (ppm).

6. The method of claim 5, wherein the contaminant comprises one of nickel ions (Ni²⁺), cobalt ions (Co²⁺), manganese ions (Mn²⁺), aluminum ions (Al³⁺), potassium ions (K⁺), calcium ions (Ca²⁺), magnesium ions (Mg²⁺), chlorine ions (Cl⁻), or fluorine ions (F⁻).

7. The method of claim 5, wherein converting the generated sodium sulfate (Na₂SO₄) to the sodium hydroxide (NaOH) and the sulfuric acid (H₂SO₄) comprises removing the contaminants from the sodium sulfate solution utilizing a single ion exchange purification.

8. The method of claim 1, further comprising recycling at least one of the sodium hydroxide (NaOH) or the sulfuric acid (H₂SO₄) to the battery manufacturing process to form a closed system.

9. A method comprising:
generating lithium sulfate (Li₂SO₄) from a battery recycling process; and
converting the generated lithium sulfate (Li₂SO₄) to lithium hydroxide (LiOH) and sulfuric acid (H₂SO₄) via an electrochemical salt-splitting process.

10. The method of claim 9, wherein the electrochemical salt-splitting process comprises one of electrolysis or bi-polar membrane electrodialysis.

11. The method of claim 10, wherein the electrochemical salt-splitting process utilizes an electrochemical electrode design comprising at least one of a stainless-steel electrode, a nickel plate steel electrode, a nickel electrode, or a mixed-metal oxide electrode.

12. The method of claim 10, wherein the electrochemical salt-splitting process utilizes a electrode design that change electrode half reactions from oxygen generation or hydrogen generation.

13. The method of claim 9, wherein generating the lithium sulfate (Li₂SO₄) from the battery recycling process comprises leaching recycled battery materials with a leaching solution comprised of sulfuric acid (H₂SO₄), hydrogen peroxide (H₂O₂), and at least one of deionized water or reverse osmosis water.

14. The method of claim 9, wherein generating the lithium sulfate (Li₂SO₄) from the battery recycling process comprises generating a lithium sulfate solution wherein a concentration of a contaminant in the lithium sulfate solution is less than 20 parts per million (ppm).

15. The method of claim 14, wherein the contaminant comprises one of nickel ions (Ni²⁺), cobalt ions (Co²⁺), copper ions (Cu²⁺), aluminum ions (Al³⁺), iron ions (Fe²⁺), calcium ions (Ca²⁺), magnesium ions (Mg²⁺), chlorine ions (Cl⁻), or fluorine ions (F⁻).

16. The method of claim 14, wherein generating the lithium sulfate solution comprises restricting battery feedstocks of the battery recycling process to at least one of battery scrap that does not contain electrolyte or battery cells that use electrolyte that does not contain fluorine.

17. The method of claim 14, wherein converting the generated lithium sulfate (Li₂SO₄) to the lithium hydroxide (LiOH) and the sulfuric acid (H₂SO₄) comprises removing the contaminant from the lithium sulfate solution utilizing a single ion exchange purification.

18. The method of claim 9, wherein converting the generated lithium sulfate (Li₂SO₄) to the lithium hydroxide (LiOH) and the sulfuric acid (H₂SO₄) comprises crystallizing the lithium hydroxide (LiOH) utilizing a single-stage crystallization.

19. The method of claim 9, wherein generating the lithium sulfate (Li₂SO₄) from the battery recycling process and converting the generated lithium sulfate (Li₂SO₄) to the lithium hydroxide (LiOH) and the sulfuric acid (H₂SO₄) is carried out in a closed system by recycling the sulfuric acid (H₂SO₄) to the battery recycling process.

20. The method of claim 9, further comprising recirculating the generated lithium hydroxide (LiOH) back into at least one of the battery recycling process or a battery manufacturing process.
